(19) United States
(12) Patent Application Publication
(10) Pub. No.: US 2014/0306454 A1
(43) Pub. Date: Oct. 16, 2014

(54) Ocean Energy Generating Device and Built-in Module Thereof

(71) Applicant: Hangzhou LHD Institute of New Energy, LLC, Hangzhou (CN)

(72) Inventors: Dong LIN, Hangzhou (CN); Changzheng HUANG, Hangzhou (CN); Zhenghan CHEN, Hangzhou (CN)

(73) Assignee: Hangzhou LHD Institute of New Energy, LLC, Hangzhou (CN)

(21) Appl. No.: 14/070,542

(22) Filed: Nov. 3, 2013

(30) Foreign Application Priority Data
Apr. 11, 2013 (CN) 2013/10123839.X

(51) Int. Cl. F03B 13/14

(52) U.S. Cl. CPC F03B 13/14
USPC 290/53

(57) ABSTRACT

The present invention provides an ocean energy generating device and a built-in module thereof. The built-in module of an ocean energy generating device includes an inner frame, a rotating shaft, a driving unit, at least one horizontal-axis generator, and at least one water flow deflector. The rotating shaft is rotatably disposed at the inner frame. The driving unit is connected with the rotating shaft to drive the rotating shaft to rotate. At least one horizontal-axis generator is fixed to the rotating shaft and a direction of an axis of the horizontal-axis generator is parallel to a horizontal plane. The water flow deflector is fixed to the inner frame. The ocean energy generating device includes at least one built-in module of the ocean energy generating device and an outer frame. The inner frame is detachably disposed in the outer frame.

### CROSS-REFERENCE TO RELATED APPLICATIONS

This Non-provisional application claims priority under 35 U.S.C. §119(a) on Patent Application No. 201320476582.1 filed in Republic of China on Aug. 6, 2013, the entire contents of which are hereby incorporated by reference.

### BACKGROUND OF THE INVENTION

1. Field of the Invention

The present invention relates to a generating device and, more particularly, to an ocean energy generating device and a built-in module thereof.

2. Description of the Related Art

Ocean energy (including tidal current energy, ocean wave energy, and ocean current energy) refers to the mechanical energy generated by the flowing of sea water. As a kind of renewable energy, the ocean energy has great development prospect and value due to its abundant reserve and wide distribution. The primary use of the ocean energy is for power generation. The working principle of ocean energy power generation is similar to that of wind power generation and conventional hydropower generation. That is, the mechanical energy of the sea water is converted into electric energy by energy conversion devices. Specifically, at first, the sea water impacts hydro turbines, the hydro turbines convert the energy of the water flow into the mechanical energy of rotation, and then the hydro turbines drive power generators to generate power via mechanical drive systems, thereby finally converting the mechanical energy to electric energy.

Nowadays, with the increasing shortage of energy and the increasing serious green house effect, energy is required to be low-carbon. Thus, clean energy, such as wind energy and the ocean energy (including tidal energy, the tidal current energy, the ocean wave energy, and the ocean current energy), will be the future direction of energy development. However, the power generating devices for the clean energy are still developing, and the utilization of the ocean energy is still in the initial stage, except for the relatively mature wind energy utilization. No general-purpose and proven devices are available. The efficiency is relatively low, and it is difficult to realize large-scale devices.

### BRIEF SUMMARY OF THE INVENTION

To overcome the deficiencies in the prior art, the present invention provides an ocean energy generating device and a built-in module thereof with convenient installation and maintenance.

To achieve one objective of the invention, the invention provides a built-in module of an ocean energy generating device including an inner frame, a rotating shaft, a driving unit, at least one horizontal-axis generator, and at least one water flow deflector. The rotating shaft is rotatably disposed at the inner frame. The driving unit is connected with the rotating shaft to drive the rotating shaft to rotate. At least one horizontal-axis generator is fixed to the rotating shaft, and a direction of an axis of the horizontal-axis generator is parallel to a horizontal plane. The water flow deflector is fixed to the inner frame.

According to an embodiment of the invention, the number of the water flow deflector is two, and the two water flow deflectors are axially symmetrically arranged and located on two sides of the horizontal-axis generator, respectively.

According to one embodiment of the invention, the water flow deflector is cylindrical, and the diameter of the water flow deflector decreases gradually.

According to one embodiment of the invention, the driving unit includes a motor and a reducer, the reducer is connected with an end of the rotating shaft, and the motor drives the rotating shaft to rotate via the reducer.

To achieve another objective of the invention, the invention further provides an ocean energy generating device, including at least a built-in module of an ocean energy generating device and an outer frame. The built-in module of the ocean energy generating device includes an inner frame, a rotating shaft, a driving unit, at least one horizontal-axis generator, and at least one water flow deflector. The rotating shaft is rotatably disposed at the inner frame. The driving unit is connected with the rotating shaft to drive the rotating shaft to rotate. At least one horizontal-axis generator is fixed to the rotating shaft, and a direction of an axis of the horizontal-axis generator is parallel to a horizontal plane. The water flow deflector is fixed to the inner frame. The inner frame is detachably disposed in the outer frame.

According to one embodiment of the invention, the ocean energy generating device further includes a dragging ring and a dragging chain, the dragging ring is disposed at the outer frame, and an end of the dragging chain is disposed at the dragging ring.

According to an embodiment of the invention, the number of the water flow deflector is two, and the two water flow deflectors are axially symmetrically arranged and located on two sides of the horizontal-axis generator, respectively.

According to one embodiment of the invention, the water flow deflector is cylindrical, and the diameter of the water flow deflector decreases gradually.

According to one embodiment of the invention, the driving unit includes a motor and a reducer, the reducer is connected with an end of the rotating shaft, and the motor drives the rotating shaft to rotate via the reducer.

To sum up, for the built-in module of the ocean energy generating device in the invention, by the rotatable rotating shaft, impellers of the horizontal-axis generator are allowed to always face the water flow, regardless of which direction the water flow flows into, such that a maximum generation power is ensured. This case is particularly appropriate for power generation by tide energy. By the water flow deflector, the water flow is intensively guided to the generator, such that the impellers of the generator bear greater stress and rotate faster, thus to improve the power generation efficiency.

For the ocean energy generating device in the invention, the overall frame body is divided into an outer frame and an inner frame, which may be detachable from each other. Hence, when the generating device of the invention is assembled, the horizontal-axis generator and the inner frame may be first assembled, and then the inner frame already installed with the horizontal-axis generator is embedded and fixed into the outer frame, so as to achieve modularized installation. Consequently, the installation and maintenance become more convenient.

Furthermore, by the dragging ring and the dragging chain, the ocean energy generating device may be effectively fixed in the water, and it is also convenient for maintenance and repair.

These and other features, aspects, and advantages of the present invention will become better understood with regard to the following description, appended claims, and accompanying drawings.

### BRIEF DESCRIPTION OF THE DRAWINGS

FIG. 1 is a top view showing a built-in module of an ocean energy generating device according to one embodiment of the present invention;

FIG. 2 is a front view of FIG. 1;

FIG. 3 is a front view showing a built-in module of an ocean energy generating device according to another embodiment of the invention;

FIG. 4 is a top view showing an ocean energy generating device according to one embodiment of the invention; and

FIG. 5 is a partially enlarged view of FIG. 4.

### DETAILED DESCRIPTION OF THE INVENTION

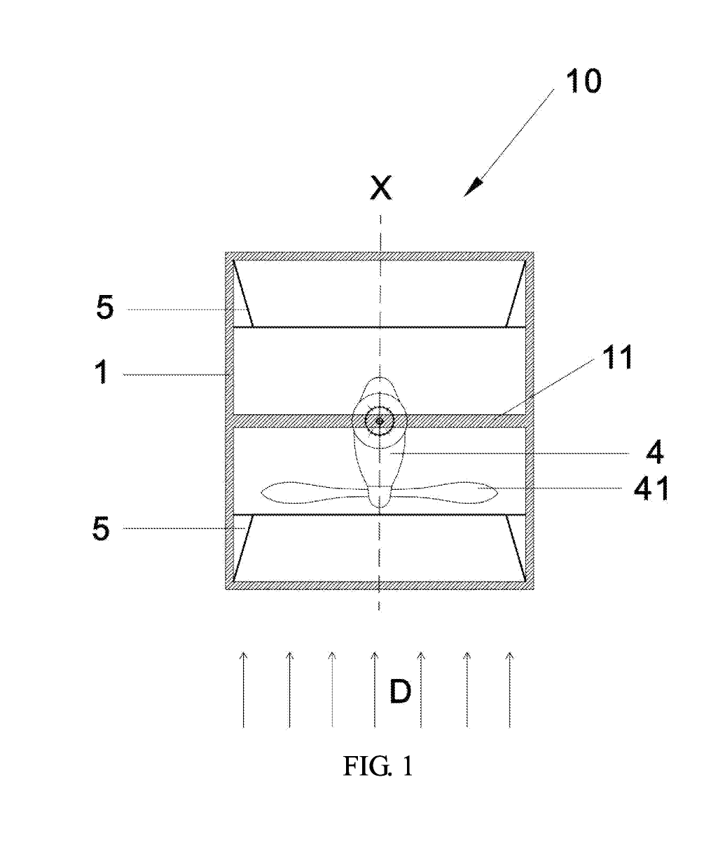

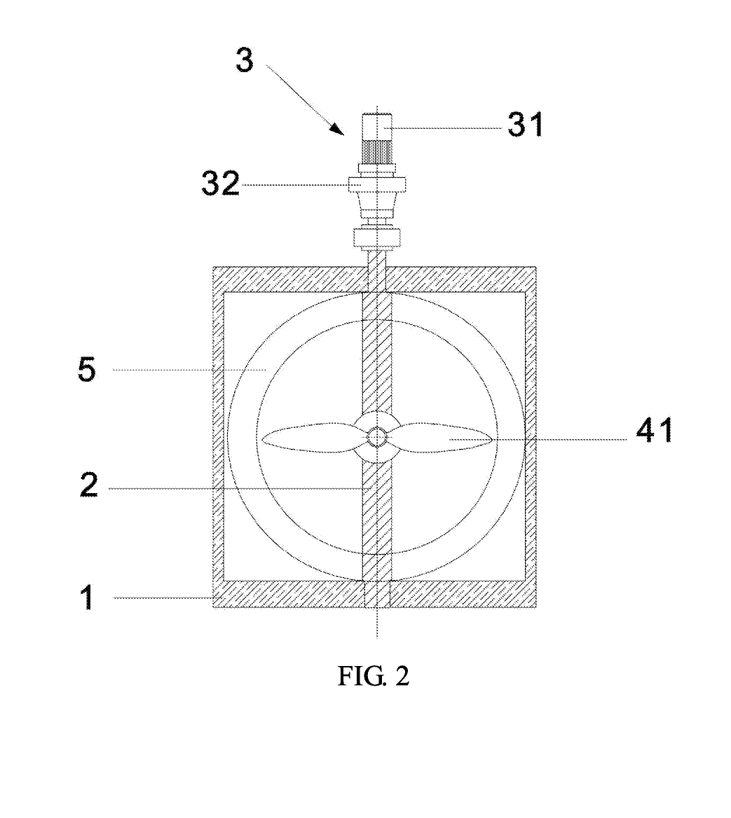

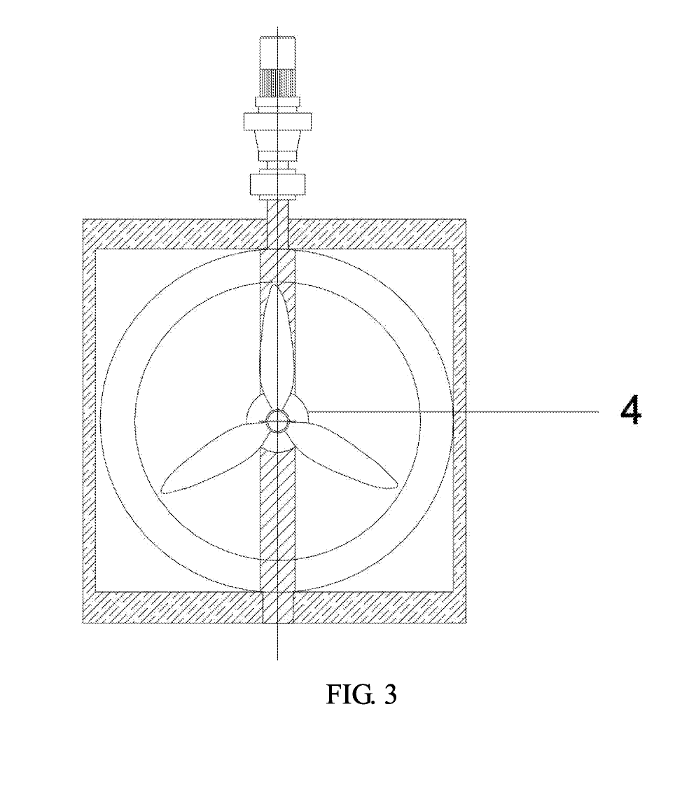

FIG. 1 shows a top view showing a built-in module of an ocean energy generating device according to one embodiment of the invention. FIG. 2 is a front view of FIG. 1. FIG. 3 is a front view showing a built-in module of an ocean energy generating device according to another embodiment of the invention. Please refer to FIG. 1 to FIG. 3 together.

The built-in module 10 of an ocean energy generating device includes an inner frame 1, a rotating shaft 2, a driving unit 3, at least one horizontal-axis generator 4 and at least one water flow deflector 5. The rotating shaft 2 is rotatably disposed at the inner frame 1. The driving unit 3 is connected with the rotating shaft 2 to drive the rotating shaft 2 to rotate. At least one horizontal-axis generator 4 is fixed to the rotating shaft 2. The direction X of the axis of the horizontal-axis generator 4 is parallel to the horizontal plane. The water flow deflector 5 is fixed to the inner frame 1.

In the embodiment, as shown in FIG. 1, the cross-section of the inner frame 1 when overlooked is rectangular, with a crosspiece 11 n the middle of the rectangular cross-section. Correspondingly, a crosspiece 11 is also provided on the bottom of the inner frame 1. Two ends of the rotating shaft 2 are rotatably disposed at the crosspiece 11.

In the embodiment, the driving unit 3 includes a motor 31 and a reducer 32, the reducer 32 is connected with an end of the rotating shaft 2 (the upper end in FIG. 2), and the motor 31 drives the rotating shaft 2 to rotate via the reducer 32. As the existing motor 31 rotates fast, the rotating rate of the motor 31 is considerably reduced by the reducer 32, so that the rotating rate and the rotating range of the rotating shaft 2 can be controlled effectively and precisely.

In the embodiment, the number of the horizontal-axis generator 4 is equal to the number of the rotating shaft 2. However, the invention is not limited thereto. In other embodiments, the number of the horizontal-axis generator 4 can be n times of the number of the rotating shaft 2, wherein n>1. That is, there may be a plurality of horizontal-axis generators 4 disposed at the same rotating shaft 2. In this embodiment, the horizontal-axis generator 4 is a generator with two impellers. However, the invention is not limited thereto. In the embodiment as shown in FIG. 3, the horizontal-axis generator 4 may be a generator with three impellers. In other embodiments, when there are several horizontal-axis generators 4, the horizontal-axis generators 4 may be one of generators with two impellers, generators with three impellers, generators with four impellers, or any combination thereof.

In the embodiment, the number of the water flow deflector 5 is two, and the two water flow deflectors 5 are axially symmetrically arranged and located on two sides of the horizontal-axis generator 4, respectively. Preferably, the water flow deflectors 5 are cylindrical, the diameter of which decreases gradually. Specifically, the two water flow deflectors 5 are axially symmetric to each other about the crosspiece 11 of the inner frame 1. As shown in FIG. 1, the diameter of the upper water flow deflector 5 decreases gradually from top to down, while the diameter of the lower water flow deflector 5 decreases from bottom to top. By the water flow deflectors 5, the water flow is intensively guided to the horizontal-axis generator 4 such that the impellers of the horizontal-axis generator 4 bear greater stress and rotate faster, thus to improve the power generation efficiency. However, the number and shape of the water flow deflectors 5 should not be limited in the invention.

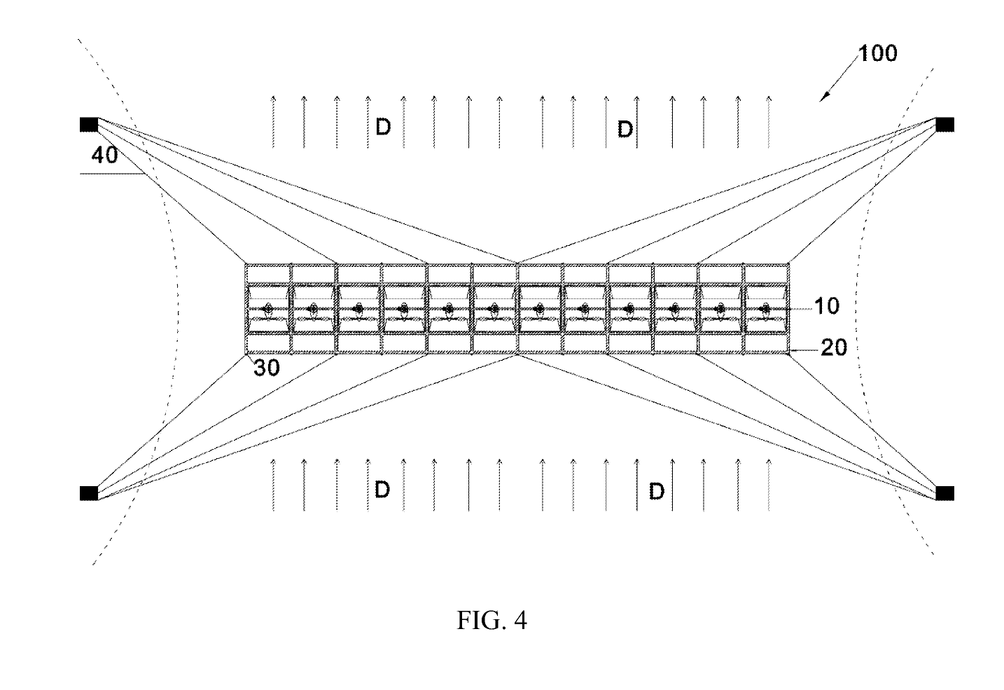

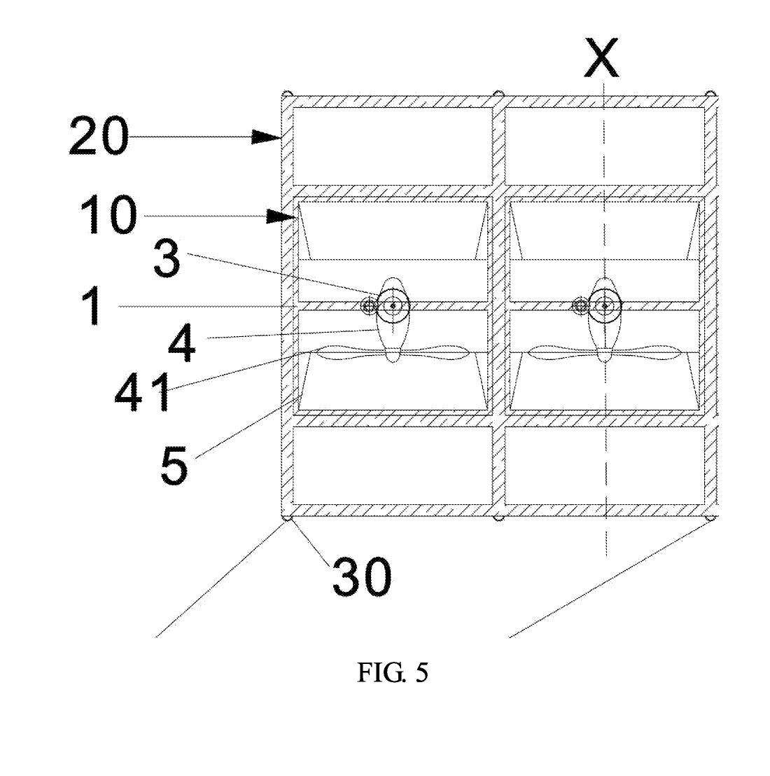

FIG. 4 is a top view showing an ocean energy generating device according to one embodiment of the invention. FIG. 5 is a partially enlarged view of FIG. 4. Please refer to FIG. 4 and FIG. 5 together.

The invention further provides an ocean energy generating device 100 including at least the built-in module 10 of the ocean energy generating device and an outer frame 20. The built-in module 10 of the ocean energy generating device 10 includes the inner frame 1, the rotating shaft 2, the driving unit 3, at least one horizontal-axis generator 4, and at least one water flow deflector 5. The rotating shaft 2 is rotatably disposed at the inner frame 1. The driving unit 3 is connected with the rotating shaft 2 to drive the rotating shaft 2 to rotate. At least one horizontal-axis generator 4 is fixed to the rotating shaft 2. The direction X of the axis of the horizontal-axis generator 4 is parallel to the horizontal plane. The water flow deflector 5 is fixed to the inner frame 1. The inner frame 1 is detachably disposed in the outer frame 20.

In this embodiment, the inner frame 1 may have a hook, and the outer frame 20 may have a slot. The inner frame 1 and the outer frame 20 are fixed together by the engagement of the hook and the slot. However, the fixing manner of the inner frame 1 and the outer frame 20 in the invention should not be limited thereto. In actual applications, one outer frame 20 may have a plurality of inner frames 1 therein.

In the embodiment, half of the outer frame 20 is formed of hollow steel tubes welded together, while the other half is formed of H-shaped steel. Specifically, the upper half of the outer frame 20 is formed of hollow steel tubes welded together. Thus, the outer frame 20 is light in weight, simple in structure, easy to process and manufacture, convenient to install, adjust and dismantle, and suitable for engineering applications. Meanwhile, the outer frame 20 can provide buoyancy to the entire ocean energy generating device 100. In addition, the lower half of the outer frame 20 may be formed of H-shaped steel to ensure that the center of gravity of the outer frame 20 falls into the lower half in order to guarantee the stability of the entire outer frame 20.

In the embodiment, the ocean energy generating device further includes a dragging ring 30 and a dragging chain 40. The dragging ring 30 is disposed at the outer frame 20, and an end of the dragging chain 40 is disposed at the dragging ring 30. Specifically, a plurality of dragging rings 30 is disposed at the outer frame 20. An end of each one of a plurality of dragging chains 40 is disposed through the dragging rings 30, while the other end thereof is fixed to piles on the shore. Preferably, there are more than four dragging rings 30, four of which are disposed four corners of the outer frame 20, respectively. Due to the arrangement of the dragging rings 30 and the dragging chains 40, the ocean energy generating device 100 can be fixed in the water, which is also convenient for maintenance and repair.

In actual applications, when the water flow flows to the ocean energy generating device 100 and the built-in module 10 thereof in a water flow direction D, the driving unit 3 does not operate. At this time, the impellers 41 of the horizontal-axis generator 4 face the water flow. When the water flow flows to the ocean energy generating device 100 and the built-in module 10 thereof in the direction opposite to the water flow direction D (in FIG. 4, from top to down), the driving unit 3 drives the rotating shaft 2 to rotate, thus to drive the horizontal-axis generator 4 to rotate by 180°. This changes the impellers 41 to face top from facing down, thereby ensuring that the impellers 41 of the horizontal-axis generator 4 always face the water flow. This case is particularly appropriate for power generation by tide energy, so that a maximum generation power is ensured.

To sum up, for the built-in module of the ocean energy generating device in the invention, by the rotatable rotating shaft, the impellers of the horizontal-axis generator are allowed to always face the water flow, regardless of which direction the water flow flows into, such that a maximum generation power is ensured. This case is particularly appropriate for power generation by tide energy. By the water flow deflector, the water flow is intensively guided to the generator, such that the impellers of the generator bear greater stress and rotate faster, thus to improve the power generation efficiency.

For the ocean energy generating device in the invention, the overall frame body is divided into an outer frame and an inner frame, which may be detachable from each other. Hence, when the generating device of the invention is assembled, the horizontal-axis generator and the inner frame may be first assembled, and then the inner frame already installed with the horizontal-axis generator is embedded and fixed into the outer frame, so as to achieve modularized installation. Consequently, the installation and maintenance become more convenient.

Furthermore, by the dragging ring and the dragging chain, the ocean energy generating device may be effectively fixed in the water, and it is also convenient for maintenance and repair.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A built-in module of an ocean energy generating device, comprising:
an inner frame;
a rotating shaft, rotatably disposed at the inner frame;
a driving unit, connected with the rotating shaft to drive the rotating shaft to rotate;
at least one horizontal-axis generator, fixed to the rotating shaft, a direction of an axis of the horizontal-axis generator being parallel to a horizontal plane; and
at least one water flow deflector, fixed to the inner frame.

2. The built-in module of an ocean energy generating device according to claim 1, wherein the number of the water flow deflector is two, and the two water flow deflectors are axially symmetrically arranged and located on two sides of the horizontal-axis generator, respectively.

3. The built-in module of an ocean energy generating device according to claim 1, wherein the water flow deflector is cylindrical, and the diameter of the water flow deflector decreases gradually.

4. The built-in module of an ocean energy generating device according to claim 1, wherein the driving unit comprises a motor and a reducer, the reducer is connected with one end of the rotating shaft, and the motor drives the rotating shaft to rotate via the reducer.

5. An ocean energy generating device, comprising:
at least one built-in module of the ocean energy generating device, comprising:
an inner frame;
a rotating shaft, rotatably disposed at the inner frame;
a driving unit, connected with the rotating shaft to drive the rotating shaft to rotate;
at least one horizontal-axis generator, fixed to the rotating shaft, a direction of an axis of the horizontal-axis generator being parallel to a horizontal plane; and
at least one water flow deflector, fixed to the inner frame; and
an outer frame, the inner frame being detachably disposed in the outer frame.

6. The ocean energy generating device according to claim 5, further comprising a dragging ring and a dragging chain, the dragging ring being disposed at the outer frame, an end of the dragging chain being disposed at the dragging ring.

7. The ocean energy generating device according to claim 5, wherein the number of the water flow deflector is two, and the two water flow deflectors are axially symmetrically arranged and located on two sides of the horizontal-axis generator, respectively.

8. The ocean energy generating device according to claim 5, wherein the water flow deflector is cylindrical, and the diameter of the water flow deflector decreases gradually.

9. The ocean energy generating device according to claim 5, wherein the driving unit comprises a motor and a reducer, the reducer is connected with one end of the rotating shaft, and the motor drives the rotating shaft to rotate via the reducer.
